(19) United States
(12) Patent Application Publication
(10) Pub. No.: US 2006/0272322 A1
(43) Pub. Date: Dec. 7, 2006

(54) Electrically actuated flow assisted exhaust valve

(75) Inventors: Kwin Abram, Columbus, IN (US); Joseph Callahan, Greenwood, IN (US)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/500,641

(22) Filed: Aug. 8, 2006

Related U.S. Application Data
(63) Continuation-in-part of application No. PCT/US05/44305, filed on Dec. 8, 2005.
(60) Provisional application No. 60/642,634, filed on Jan. 10, 2005.

(51) Int. Cl. F01N 7/00; F16K 1/22

(52) U.S. Cl. 60/324; 251/305

(57) ABSTRACT

An exhaust valve includes a flapper valve that is pivotable within an exhaust component between open and closed positions. The flapper valve is supported on a shaft that is coupled to an actuator. The flapper valve comprises a disc-shaped body that is fixed to the support shaft such that the disc-shaped body is asymmetrical about the axis of rotation.

### RELATED APPLICATIONS

This application is a continuation-in-part application of PCT/US2005/044305 filed on Dec. 28, 2005, which claims priority to U.S. provisional application No. 60/642,634, which was filed on Jan. 10, 2005.

### TECHNICAL FIELD

This invention generally relates to a flapper valve as used in an exhaust system, wherein the flapper valve has improved noise and operational characteristics.

### BACKGROUND OF THE INVENTION

Noise attenuation valves are often used in vehicle exhaust systems to reduce noise generated during vehicle operation. For example, a noise attenuation valve is incorporated into a muffler to reduce noise generated by a vehicle engine. Traditionally, the noise attenuation valve includes a flapper valve mounted on a shaft that pivots the flapper valve within an inlet tube formed within the muffler. The flapper valve has a disc-shaped body that rotates within the inlet tube to vary exhaust gas flow area. The flapper valve pivots between an open position, i.e., a maximum exhaust flow position, and a closed position, i.e., a minimum exhaust flow position. Under high exhaust flow conditions, it is desirable to maintain the flapper valve in the open position.

The shaft is coupled to an actuator with a linkage assembly. A controller controls the actuator to rotate the shaft via the linkage assembly. The actuator can be either an electric actuator or a vacuum actuator. As the shaft rotates, the flapper valve varies the exhaust gas flow area by rotating amongst various positions between the maximum and minimum exhaust flow positions as needed to attenuate noise.

Traditionally, both electric and vacuum actuators have had problems with actuation noise, back pressure, and maintaining the flapper valve in an open position under high exhaust flow conditions. In one known configuration, the shaft is coupled to the flapper valve such that the shaft extends underneath the flapper valve when the flapper valve is in the maximum exhaust flow position. Under high exhaust flow conditions, the flapper valve has a resultant torque that has a tendency to pivot the flapper valve toward the closed position.

One proposed solution involved changing an angle of attack, i.e. the angle from a horizontal position, of the flapper valve when in the open position, however, this solution was unsuccessful. Traditionally, the flapper valve is positioned at a positive angle of attack in the open position, which exposes a top side of the flapper valve to exhaust flow. As discussed above, in this orientation the flapper valve has a tendency to rotate towards the closed position. Decreasing the angle of attack, such that a bottom surface of the flapper valve is exposed to exhaust flow, does not change this tendency.

Thus, to keep the flapper valve open under such high exhaust flow conditions, a large spring is required to prevent the flapper valve from closing. This large spring is coupled to the flapper valve and provides a significant spring force that holds the flapper valve in the open position. One disadvantage with this solution is that when the controller determines that the flapper valve should move from the open position toward the closed position, the significant spring force must be overcome, which results in an increase in actuator noise. Another disadvantage is that amperage and vacuum needed to overcome the spring force must also be increased in operation for both electric and vacuum actuators, respectively.

For the above reasons, it would be desirable provide a flapper valve assembly that can be biased toward an open position without requiring additional springs. The flapper valve assembly should also reduce actuation noise and have improved back pressure characteristics in addition to overcoming other deficiencies in the prior art as outlined above.

### SUMMARY OF THE INVENTION

An exhaust valve assembly for an exhaust component includes a flapper valve that is pivotable within a valve housing between open and closed positions. The flapper valve is supported on a shaft that defines an axis of rotation. The flapper valve comprises a disc-shaped body that is fixed to the support shaft such that the disc-shaped body is asymmetrical about the axis of rotation.

In one example, the disc-shaped body includes first and second disc surfaces that face opposite from each other. The support shaft is attached to one of the first and second surfaces such that a resultant torque generated by exhaust flow across the flapper valve when in the nominally open position acts in such a direction to hold the flapper valve in the nominally open position.

In one example, if the flapper valve is in the closed position with no gas flow, application of the gas flow will force the flapper valve to move into the open position. To keep the flapper valve closed with the asymmetrical configuration, an external force element is utilized. A vacuum or electrical current provided by a valve actuator is used to overcome the external force to open the flapper valve as needed. The force element is configured in such a way that once a specified flow condition is achieved, the flapper valve is moved into the open position by the gas flow itself. As such, the flapper valve is defaulted to the closed position without requiring electric current or vacuum, but will open as the gas flow increases to overcome the force of the force element if current or vacuum used to open the flapper valve is absent due to a failure in the electrical of vacuum system.

The subject invention thus provides an exhaust valve with improved noise and operational characteristics. These and other features of the present invention can be best understood from the following specification and drawings, the following of which is a brief description.

These and other features of the present invention can be best understood from the following specification and drawings, the following of which is a brief description.

### BRIEF DESCRIPTION OF THE DRAWINGS

FIG. 1 is a perspective view of an exhaust component incorporating the subject invention.

FIG. 2 is a schematic front view of a noise attenuation valve in an open position.

FIG. 3 is a schematic side view of the noise attenuation valve of FIG. 2 in the closed position.

FIG. 4 is a view similar to FIG. 3 but showing the noise attenuation valve in the open position.

FIG. 5 is a perspective view of a valve body from the embodiment shown in FIGS. 1-4.

FIG. 6A is a schematic view of one example of a flapper valve resultant torque configuration.

FIG. 6B is a schematic view of another example of a flapper valve resultant torque configuration.

FIG. 7A is a schematic view of a center shaft with a flapper valve in a closed position.

FIG. 7B is a schematic view of a non-centered shaft with a flapper valve in a closed position.

FIG. 7C is a schematic view of the flapper valve of FIG. 7B moving to an open position.

### DETAILED DESCRIPTION OF THE PREFERRED EMBODIMENT

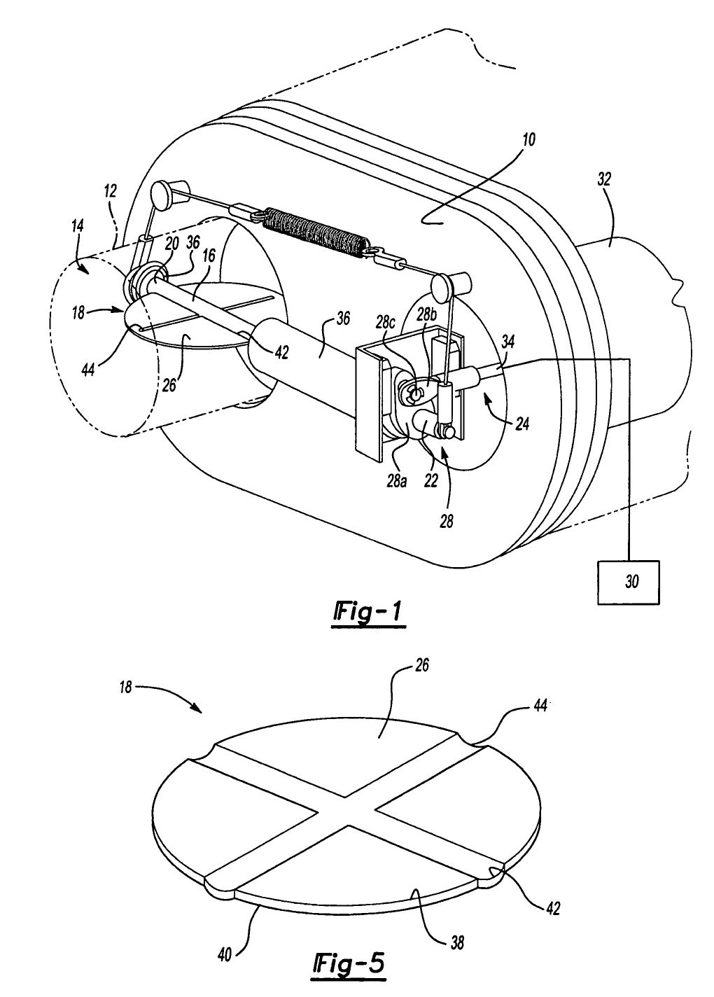

As shown in FIG. 1, an exhaust system component, such as a muffler, includes a datum plate 10 that supports an inlet tube 12. The inlet tube 12 defines an inner cavity 14 that directs exhaust flow through the exhaust system component. In the example shown in FIG. 1, exhaust flows right to left through the inlet tube 12 and into the muffler. It should be understood that the muffler is just one example of an exhaust system component that benefits from the subject invention detailed below, and that other exhaust system components could also benefit from the subject invention.

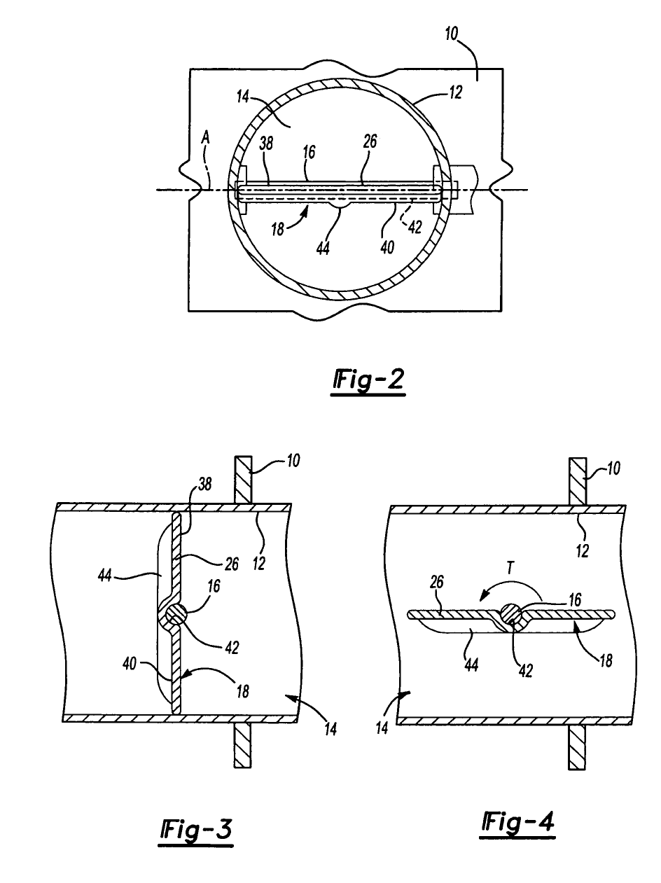

A noise attenuation valve assembly includes a shaft 16 and a flapper valve 18 that is fixed to the shaft 16. Preferably, the shaft 16 and flapper valve 18 are welded together, however, other attachment methods could also be used. The shaft 16 has a first end 20 supported by the inlet tube 12 and a second end 22 that extends out from the inlet tube 12 toward an actuator 24. Each of the first 20 and second 22 ends is pivotally supported within a bushing 36 as known, to allow the shaft 16 to pivot the flapper valve 18 relative to the inlet tube 12 about an axis A, which is best shown in FIG. 2.

The flapper valve 18 has a disc-shaped body 26 that rotates within the inner cavity 14 to vary exhaust gas flow area. The flapper valve 18 pivots between an open position (FIG. 2) and a closed position (FIG. 3). In the open position, the flapper valve 18 provides maximum exhaust flow area, and in the closed position, the flapper valve 18 provides minimum, or no exhaust flow through the inlet tube 12. Under high exhaust flow conditions, it is desirable to maintain the flapper valve 18 in the open position.

As shown in FIG. 1, the shaft 16 is coupled to the actuator 24 with a linkage assembly 28. A controller 30 controls the actuator 24 to rotate the shaft 16 via the linkage assembly 28. In the example shown, the linkage assembly 28 includes a first member 28a that is fixed to the shaft 16 and a second member 28b that is coupled to the first member 28a with a pin 28c. The second member 28b is coupled to the actuator 24.

The actuator 24 can be either an electric actuator or a vacuum actuator. In the example shown, the actuator 24 comprises a solenoid (not shown) enclosed within a housing 32. The solenoid includes a plunger or linear actuator 34 that is coupled to the second member 28b of the linkage assembly 28. The linear actuator 34 drives the linkage assembly 28 to rotate the shaft 16. As the shaft 16 rotates, the flapper valve 18 varies the exhaust gas flow area by rotating among various positions between the open and closed positions as needed to attenuate noise.

As discussed above, the flapper valve 18 includes a disc-shaped body 26. As shown in FIG. 2, the disc-shaped body 26 has a first surface 38 and a second surface 40 that faces opposite from the first surface 38. When the flapper valve 18 is in the open position, i.e., maximum exhaust flow position, as shown in FIGS. 1 and 2, the first surface 38 is an upper surface and the second surface 40 is a lower surface. In the open position, the upper and lower surfaces are generally horizontal. When the flapper valve 18 is in the closed position, i.e., minimum exhaust flow position (FIG. 3), the first surface 38 is a side surface facing the datum plate 10 and the second surface 40 is a side surface facing away from the datum plate 10. In the closed position, both side surfaces are generally vertical.

The shaft 16 is directly attached to the first surface 38 of the disc-shaped body 26 such that the shaft 16 is on top of the disc-shaped body 26 when in the open position. This unique shaft/flapper valve mounting configuration provides a resultant torque T, shown schematically in FIG. 4, which automatically biases the flapper valve 18 toward the open position without requiring any additional springs or other similar biasing components. This is achieved by designing flapper geometry to position a center of pressure caused by exhaust flow to be offset from the shaft. This will be discussed in greater detail below.

As best shown in FIGS. 3-5, the first surface 38 includes a first groove 42 that receives the shaft 16. The first groove 42 extends across the disc-shaped body 26 and is generally parallel to the axis A (FIG. 2). The first groove 42 provides a concave surface on the first surface 38 and a convex surface on the second surface 40.

The shaft 16 is positioned in the first groove 42 such that a portion of the shaft 16 extends outwardly beyond the first surface 38 of the disc-shaped body 26. Thus, the shaft 16 is vertically higher relative to ground than the first surface 38 of the disc-shaped body 26 when the flapper valve 18 is in the open or maximum exhaust flow position. Accordingly, when in the closed position, the shaft 16 is closer to the datum plate 10 than the first surface 38 of the flapper valve 18.

The first surface 38 also includes a second groove 44 (FIGS. 2-5) that extends generally in the direction of exhaust gas flow and is transverse to the first groove 42. In the example shown, the second groove 44 intersects the first groove 42, and is perpendicular to both the first groove 42 and the axis A. The second groove 44 similarly provides a concave surface on the first surface 38 and a convex surface on the second surface 40.

By positioning the flapper valve 18 on the shaft 16 in such a configuration, the resultant torque T on the shaft 16 biases the linkage assembly 28 and pushes the flapper valve 18 to the open position. The resultant torque T increases as exhaust flow increases. Thus, under high exhaust flow conditions, the flapper valve is naturally and automatically biased toward the open position. No additional spring elements are required. Thus, actuation noise is decreased and back pressure characteristics are improved. Further, in this unique configuration, an angle of attack of the flapper valve 18 (i.e. the angle of the flapper valve 18 relative to a horizontal position), can be increased or decreased up to five degrees from the horizontal and still remain open under high flow conditions.

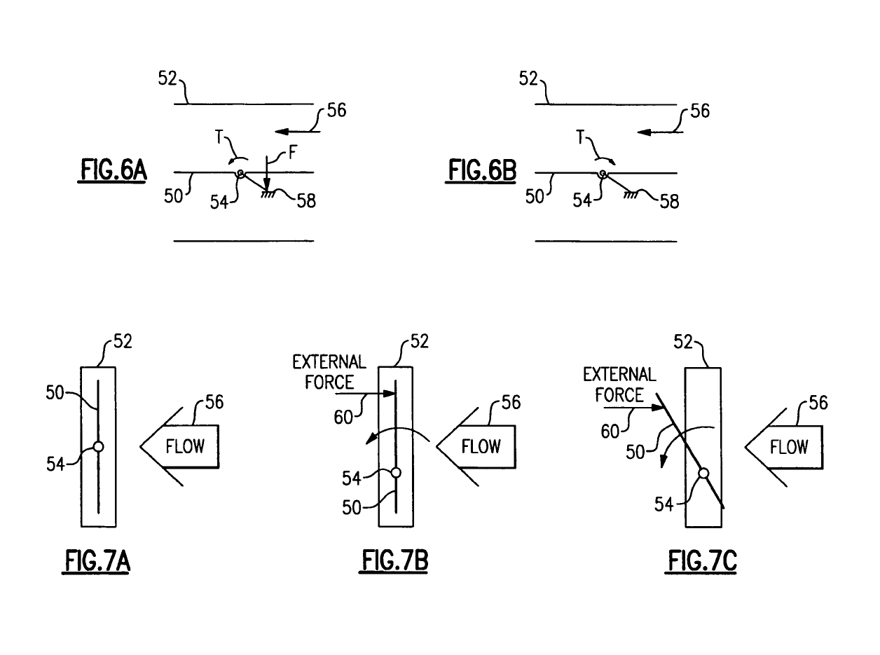

Thus, in the present invention the valve is configured to generate a resultant torque that holds a flapper valve in an open position without requiring any additional holding elements. Examples of the resultant torque configurations are shown in FIGS. 6A and 6B.

As shown in FIG. 6A, a flapper valve 50 is positioned within a valve housing 52 and is connected to a shaft 54. A resultant torque T is generated in a counter-clockwise direction about the shaft 54 such that a force F, which increases as gas flow 56 increases, must be used to keep the flapper valve 50 open on an opening stop 58.

As shown in FIG. 6B, the flapper valve 50 valve is configured with an asymmetric geometry, such that a resultant torque T generated by gas flow 56 across the flapper valve 50, in its nominally open position, acts in such a direction (clockwise) as to push the flapper valve 50 towards and onto associated opening stops 58. This is achieved by designing the flapper geometry to position a center of pressure caused by gas flow 56 to be either in front of or behind the shaft 54, with respect to flow direction, to generate the resultant torque T in the required direction as shown. In this configuration, no additional force is required to hold the flapper valve 50 in the open position.

The subject invention also provides the additional benefit of providing a flow activated failsafe opening. To extend the effective noise attenuation of electric and vacuum actuated exhaust valves, the flapper valve 50 must be kept in the nominally closed position. To keep the flapper valve 50 in the nominally closed position, the flapper valve 50 could be designed to default to the closed position using vacuum or electric current to open the flapper valve 50. Or, the flapper valve 50 could be designed to use vacuum or electric current to keep the flapper valve 50 in the closed position with a default being to the open position when the vacuum or electric current is removed. If the flapper valve 50 is designed such that the flapper valve 50 defaults closed, then if an electric or vacuum circuit fails, the exhaust flow will be blocked and there will be an acute lack of power when wide open throttle is applied. If the flapper valve 50 is designed such that the flapper valve 50 defaults open, then there will be a constant electric current draw, or running of a vacuum pump, to keep the flapper valve 50 closed. As the closed condition is the position of the flapper valve 50 at the largest percentage of its operation, using electric current, or vacuum, would be a significant drain on an electrical system for the associated engine.

When the shaft 54 is located at a center of the valve housing 52, and the flapper valve 50 is symmetrical about a centerline of the shaft as shown in FIG. 7A, gas flow 56 through the valve housing 52 will keep the flapper valve 50 in the closed position. To open the flapper valve 50, some external force would be required to compensate for the force of the gas flow 56.

By offsetting the shaft 54 relative to a center of the flapper valve 50, such that the flapper valve 50 is non-symmetric about the centerline of the shaft 54, the flapper valve 50 is unbalanced within the valve housing 52 as shown in FIG. 7B. If the flapper valve 50 is in the closed position with no gas flow, application of the gas flow 56 will force the flapper valve 50 to move into the open position. To keep the flapper valve 50 closed with the offset configuration, some external force applied by a force element 60 must be utilized. The force needed to keep the flapper valve 50 in the closed position would increase as flow increases. A vacuum or electrical current would be used to overcome the external force to open the flapper valve 50 as needed.

In one example, the force element 60 comprises a spring that is used to keep the flapper valve 50 closed, however, other force elements could also be used. The spring would be configured in such a way that once a specified flow condition is achieved, the flapper valve 50 could be moved into the open position as shown in FIG. 7C by the gas flow 56 itself. As such, the flapper valve 50 is defaulted to the closed position without requiring electric current or vacuum, but will open as the gas flow 56 increases to overcome the force of the force element 60 if current or vacuum used to open the flapper valve is absent due to a failure in the electrical or vacuum system.

Offsetting the shaft relative to the flapper valve 50 also provides a flapper geometry configuration where the center of pressure caused by exhaust flow is offset from the shaft 54. This asymmetrical configuration provides the resultant torque T, which is generated by gas flow 56 across the flapper valve 50 in its nominally open position, and which acts to push the flapper valve 50 towards the open position as described above.

It should be understood that terms such as upper and lower, and clockwise and counter-clockwise are merely used for descriptive purposes and are not to be construed as limitations of the present invention. Further, although a preferred embodiment of this invention has been disclosed, a worker of ordinary skill in this art would recognize that certain modifications would come within the scope of this invention. For that reason, the following claims should be studied to determine the true scope and content of this invention.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An exhaust valve assembly comprising:
a flapper valve pivotable about an axis of rotation between a nominally open position and a nominally closed position wherein said flapper valve comprises a generally disc-shaped body having a first surface and a second surface facing opposite said first surface;
a support shaft attached to one of said first and said second surfaces such that a resultant torque generated by exhaust flow across the flapper valve when in the nominally open position acts in such a direction to hold said flapper valve in the nominally open position; and
an actuator coupled to said support shaft to control pivotal movement of said support shaft and said flapper valve.

2. The exhaust valve assembly according to claim 1 wherein said disc-shaped body is asymmetrical about said axis of rotation.

3. The exhaust valve assembly according to claim 1 wherein a center of pressure on said disc-shaped body caused by said gas flow is offset from said support shaft.

4. The exhaust valve assembly according to claim 3 wherein said support shaft extends across said disc-shaped body in a first direction transverse to said gas flow and wherein said center of pressure is offset from said support shaft in a second direction transverse to said first direction.

5. The exhaust valve assembly according to claim 1 wherein said support shaft is coaxial with said axis of rotation with said disc-shaped body being asymmetrical about said axis of rotation such that when said flapper valve is in the nominally closed position under a no flow condition, subsequent generation of gas flow will force the flapper valve to move to the nominally open position without requiring any additional actuation elements.

6. The exhaust valve assembly according to claim 5 including an external force element that holds said flapper valve in the nominally closed position.

7. The exhaust valve assembly according to claim 6 wherein under normal operating conditions said actuator acts to overcome a holding force exerted by said external force element to move said flapper valve from the nominally closed position to the nominally open position, and wherein under a failure condition of said actuator said holding force is overcome as said gas flow reaches a predetermined level to allow said flapper valve to move into the nominally open position.

8. The exhaust valve assembly according to claim 1 wherein said flapper valve body is positioned within an inlet tube for a muffler.

9. An exhaust valve assembly comprising:
a support shaft defining an axis of rotation;
a flapper valve pivotable about said axis of rotation between a nominally open position and a nominally closed position; and
wherein said flapper valve comprises a disc-shaped body that is fixed to said support shaft such that said disc-shaped body is asymmetrical about said axis of rotation.

10. The exhaust valve assembly according to claim 9 including an actuator coupled to said support shaft to control pivotal movement of said support shaft and said flapper valve.

11. The exhaust valve assembly according to claim 9 wherein a resultant torque generated by exhaust flow across said flapper valve when in the nominally open position acts in such a direction to hold said flapper valve in the nominally open position.

12. The exhaust valve assembly according to claim 11 wherein a center of pressure on said disc-shaped body caused by said gas flow is offset from said support shaft.

13. A method of operating an exhaust valve in an exhaust component comprising the steps of:
(a) providing a support shaft defining an axis of rotation and a flapper valve comprising a disc-shaped body;
(b) fixing the disc shaped body to the support shaft such that the disc-shaped body is asymmetrical about the axis of rotation; and
(c) generating a resultant torque by exhaust flow across the flapper valve when in the nominally open position which acts in such a direction to hold the flapper valve in the nominally open position.

14. The method according to claim 13 including providing a center of pressure on the disc-shaped body caused by the exhaust flow that is offset from the support shaft.
